(19) United States
(12) Patent Application Publication
(10) Pub. No.: US 2014/0106121 A1
(43) Pub. Date: Apr. 17, 2014

(54) METHOD OF MANUFACTURING TAPE-LIKE PATTERN MEDIUM

(71) Applicant: PANASONIC CORPORATION, Osaka (JP)

(72) Inventors: Motomi Hitani, Okayama (JP); Takahiro Okazaki, Okayama (JP); Akinaga Natsui, Osaka (JP)

(73) Assignee: PANASONIC CORPORATION, Osaka (JP)

(21) Appl. No.: 14/119,053

(22) PCT Filed: Aug. 28, 2012
(86) PCT No.: PCT/JP2012/005412

§ 371 Date: Nov. 20, 2013

(30) Foreign Application Priority Data
Aug. 30, 2011 (JP) 2011-187690

(51) Int. Cl. B29C 59/16

(52) U.S. Cl. CPC B29C 59/16
USPC 428/141; 427/510; 118/620

(57) ABSTRACT

There is provided a method of manufacturing a tape-like pattern medium, with which a tape-like pattern medium with improved mechanical strength is manufactured. Said method of manufacturing a tape-like pattern medium comprises a coating step of forming an ultraviolet curing resin layer (2) by coating a film substrate (3) surface with an ultraviolet curing resin containing a photopolymerization initiator that absorbs ultraviolet rays of a wavelength that will pass through the film substrate (3), a pattern formation step of bringing the ultraviolet curing resin layer (2) into close contact with a roll-shaped master stamper (10) and forming a texture pattern (5) corresponding to a texture pattern (101) of the master stamper (10) in the ultraviolet curing resin layer (2), and an irradiation step of curing the ultraviolet curing resin layer (2) by irradiating the ultraviolet curing resin layer (2) in which the texture pattern (5) has been formed with ultraviolet rays in a state in which the surrounding oxygen has been removed.

### TECHNICAL FIELD

The present invention relates to a method of manufacturing a tape-like pattern medium, to a tape-like pattern medium, and to a device for manufacturing a tape-like pattern medium.

### BACKGROUND ART

Patent Literature 1 discloses a manufacturing method in which ultraviolet rays are emitted from a substrate side in a state in which an ultraviolet curing resin applied to the substrate surface has been brought into close contact with a master stamper, thereby curing the ultraviolet curing resin transferring the fine texture pattern of the master stamper onto the ultraviolet curing resin layer.

### CITATION LIST

### Patent Literature

Patent Literature 1: Japanese Laid-Open Patent Application S60-224532

### SUMMARY

### Technical Problem

This disclosure provides a method of manufacturing a tape-like pattern medium which is effective at efficiently manufacturing a tape-like pattern medium with improved mechanical strength, and also provides a tape-like pattern medium and a device for manufacturing a tape-like pattern medium.

### Solution to Problem

The method of manufacturing a tape-like pattern medium disclosed herein comprises a coating step of forming an ultraviolet curing resin layer by coating a film substrate surface with an ultraviolet curing resin containing a photopolymerization initiator that absorbs ultraviolet rays of a wavelength that will pass through the film substrate, a pattern formation step of bringing the ultraviolet curing resin layer into close contact with a roll-shaped master stamper and forming a texture pattern corresponding to a texture pattern of the master stamper in the ultraviolet curing resin layer, and an irradiation step of curing the ultraviolet curing resin layer by irradiating the ultraviolet curing resin layer in which the texture pattern has been formed with ultraviolet rays in a state in which the surrounding oxygen has been removed.

### Advantageous Effects

The method of manufacturing a tape-like pattern medium, tape-like pattern medium, and device for manufacturing a tape-like pattern medium disclosed herein are effective at efficiently manufacturing a tape-like pattern medium with improved mechanical strength.

### BRIEF DESCRIPTION OF DRAWINGS

FIG. 1 is an oblique view of the tape-like pattern medium pertaining to Embodiment 1;

FIG. 2 is a simplified diagram of the device for manufacturing a tape-like pattern medium pertaining to Embodiment 1;

FIGS. 3a to 3c are simplified cross sections illustrating the method of manufacturing a tape-like pattern medium pertaining to Embodiment 1;

FIG. 4 is a flowchart of the method of manufacturing a tape-like pattern medium pertaining to Embodiment 1;

FIG. 5 is a graph of the optical transmissivity by wavelength of the film substrate of the tape-like pattern medium pertaining to Embodiment 1;

FIG. 6 is a graph of optical transmissivity versus wavelength for the film substrate, and a graph of the absorbancy versus wavelength for the photopolymerization initiator (1) in Comparative Example 1;

FIG. 7 is a graph of optical transmissivity versus wavelength for the film substrate, and a graph of the absorbancy versus wavelength for the photopolymerization initiator (2) in Comparative Example 2;

FIG. 8 is a graph of optical transmissivity versus wavelength for the film substrate, and a graph of the absorbancy versus wavelength for the photopolymerization initiator (3) in Comparative Example 3;

FIG. 9 is a graph of optical transmissivity versus wavelength for the film substrate, and a graph of the absorbancy versus wavelength for the photopolymerization initiator (4) in Comparative Example 1;

FIG. 10 is a graph of the relation between degree of curing and film thickness of the ultraviolet curing resin in the air;

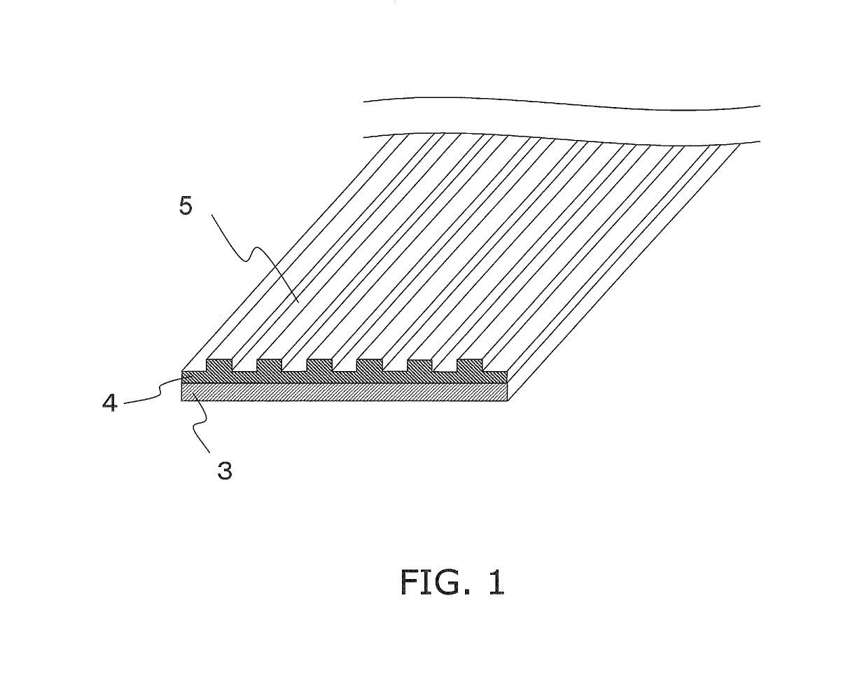

FIG. 1 la is a table of the results of Working Examples 2 to 4 and Comparative Examples 4 to 6, and FIG. 11b is a graph of the table in FIG. 11a; and

FIG. 12 is a simplified diagram of the device for manufacturing a tape-like pattern medium in a modification example of Embodiment 1.

### DESCRIPTION OF EMBODIMENTS

Embodiments will now be described in detail through reference to the drawings as needed. Unnecessarily detailed description may sometimes be omitted, however. For example, detailed description of already known facts or redundant description of components that are substantially the same may be omitted. This is to avoid unnecessary repetition in the following description, and facilitate an understanding on the part of a person skilled in the art.

The inventors have provided the appended drawings and the following description in order that a person skilled in the art might fully understand what is disclosed herein, and do not intend for these to limit what is discussed in the patent claims.

First, the problem discovered by the inventors will be described.

In order to manufacture a pattern medium to which the texture pattern of a master stamper has been transferred, there have been studies in which an ultraviolet curing resin is subjected to a curing reaction by irradiating a film substrate coated with the ultraviolet curing resin with ultraviolet rays from the film substrate side. In this method, the curing reaction of the ultraviolet curing resin is greatly dependent on the optical transmissivity of the film substrate being used.

The mechanical strength that is generally required of a pattern formation resin layer is that it have a pencil hardness of at least 3H, but when the film substrate absorbs ultraviolet rays of the wavelength band necessary for the curing reaction of the ultraviolet curing resin, not enough ultraviolet rays are obtained for the curing of the ultraviolet curing resin, and insufficient curing ends up forming a pattern resin layer with low mechanical strength.

Other methods for dealing with insufficient curing involve increasing the amount of photopolymerization initiator contained in the ultraviolet curing resin, or increasing the amount of ultraviolet irradiation. When the amount of photopolymerization initiator is increased, then a large amount of unreacted photopolymerization initiator will remain behind, leading to a decrease in mechanical strength. When the amount of ultraviolet irradiation is increased, this requires an increase in the curing time, or additional irradiation with ultraviolet rays in a nitrogen atmosphere or a vacuum, causing a decrease in production efficiency or requiring new infrastructure, among other such problems.

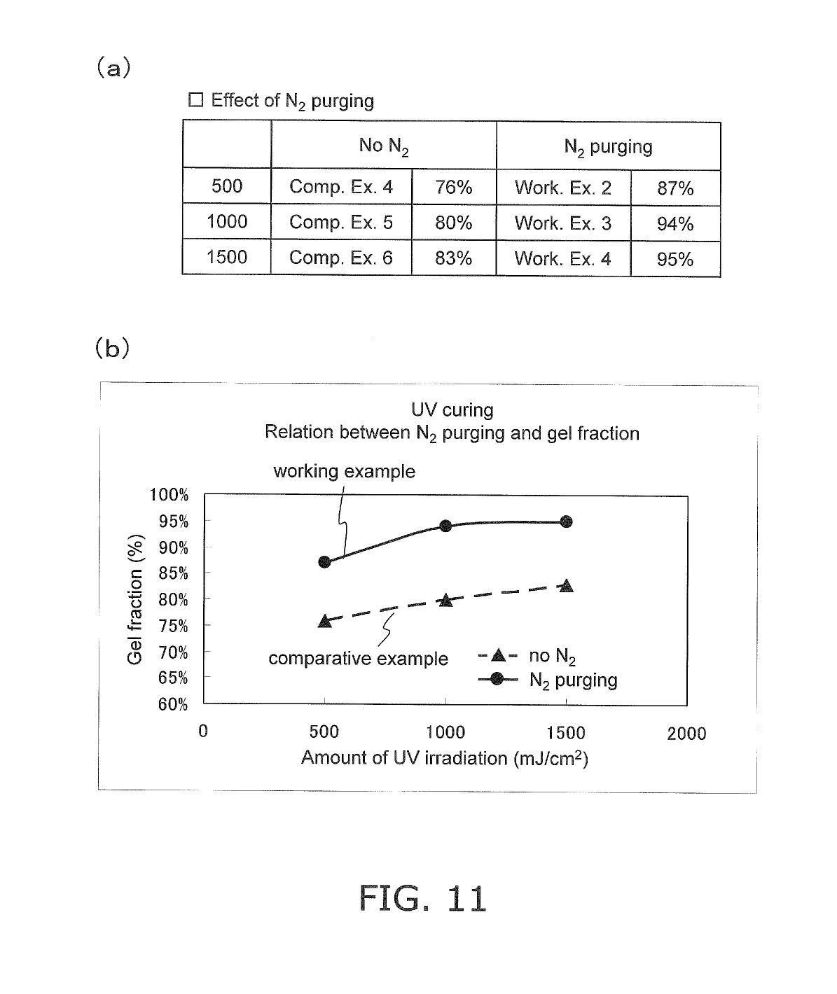

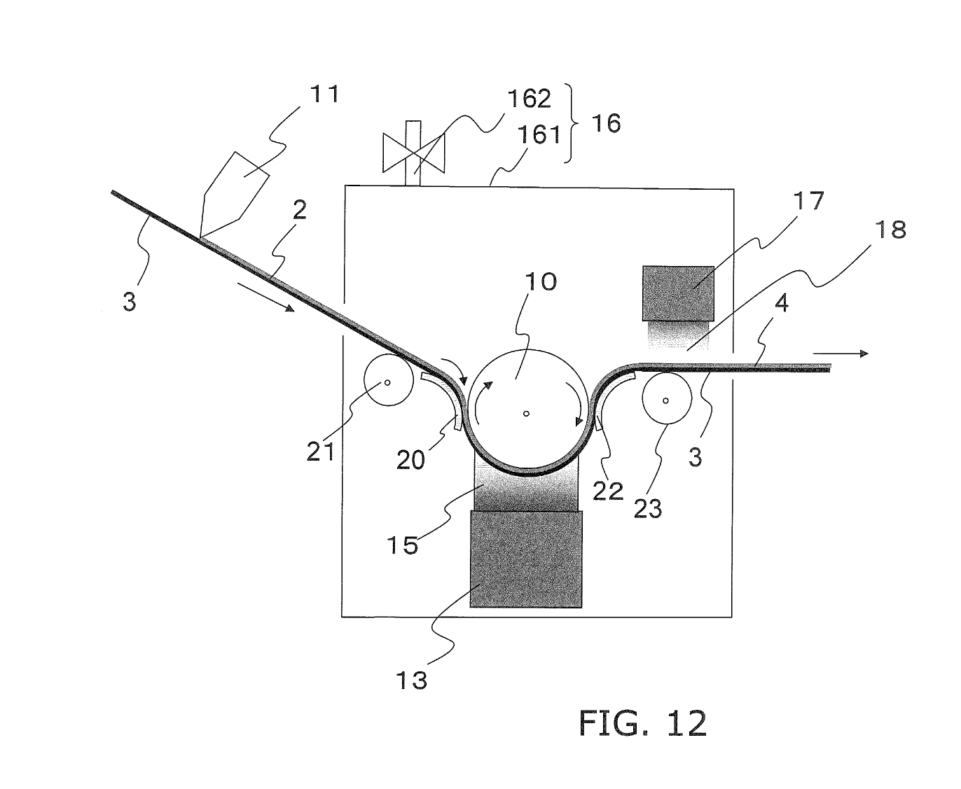

Furthermore, the inventors discovered that even if irradiation with ultraviolet rays is performed to compensate for insufficient curing after pattern formation in the air, if the resin thickness is reduced below 1.0 μm in order to achieve higher density, oxygen will impair curing and make it difficult to promote sufficient curing of the pattern resin layer. FIG. 10 is a graph of the relation between degree of curing and film thickness of the ultraviolet curing resin. The vertical axis is the degree of curing (gel fraction (%)), and the horizontal axis is the thickness (μm). As shown in FIG. 10, with irradiation at a given amount of ultraviolet rays, the degree of curing drops off sharply when the thickness is less than 1 μm.

Thus, the inventors found that in the manufacture of a tape-like pattern medium, a problem occurs in that ultraviolet rays are absorbed by the film substrate, and if the resin thickness is reduced in an effort to achieve higher density, then the curing of the ultraviolet curing resin will end up being insufficient.

Embodiment 1 pertaining to this disclosure will now be described.

### Embodiment 1

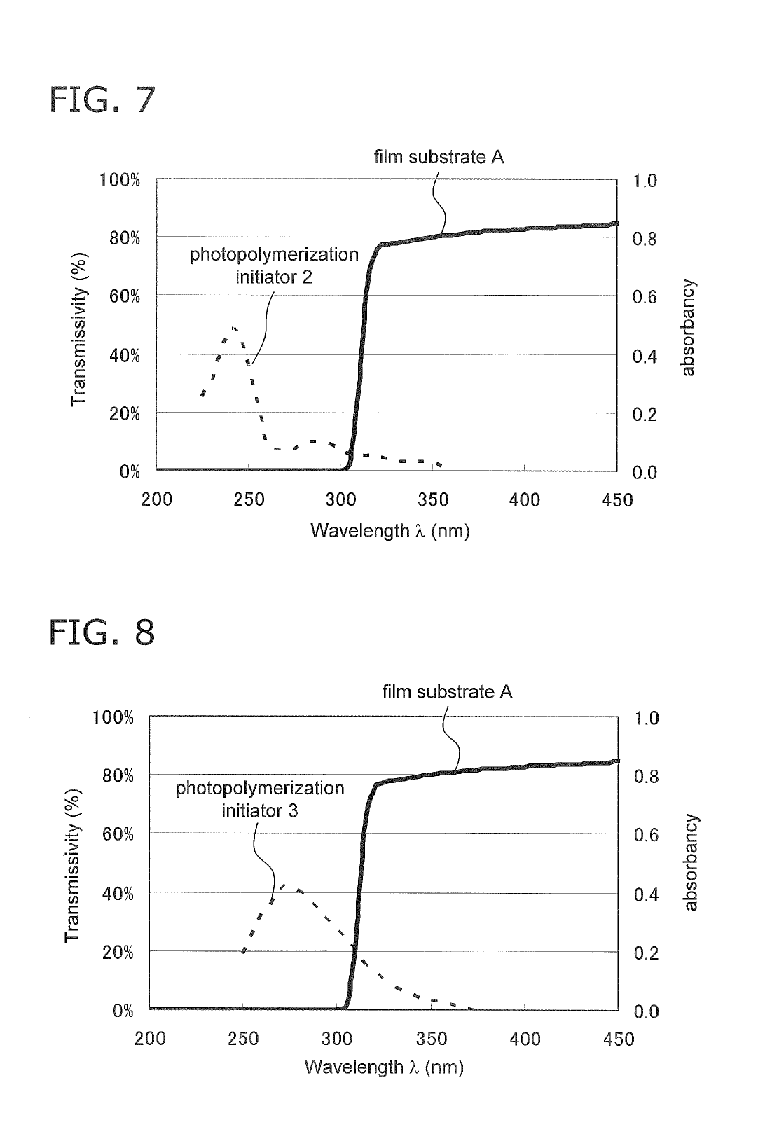

Embodiment 1 will now be described through reference to FIGS. 1 to 10.

### 1-1. Configuration of Tape-Like Pattern Medium

FIG. 1 is an oblique view of the tape-like pattern medium pertaining to Embodiment 1. As shown in FIG. 1, the tape-like pattern medium in Embodiment 1 is made up of a film substrate 3 and a pattern resin layer 4 that is provided over the film substrate 3 and on which is formed a texture pattern 5 corresponding to a texture pattern on the surface of a master stamper.

The film substrate 3 is a film substrate having optical transmissivity, such as glass, polycarbonate, polyester, or aramid.

The pattern resin layer 4 is formed by using an ultraviolet curing resin that includes a photopolymerization initiator and is made up of an acrylic ester monomer, an acrylic ester oligomer, or both.

### 1-2. Device for Manufacturing Tape-Like Pattern Medium

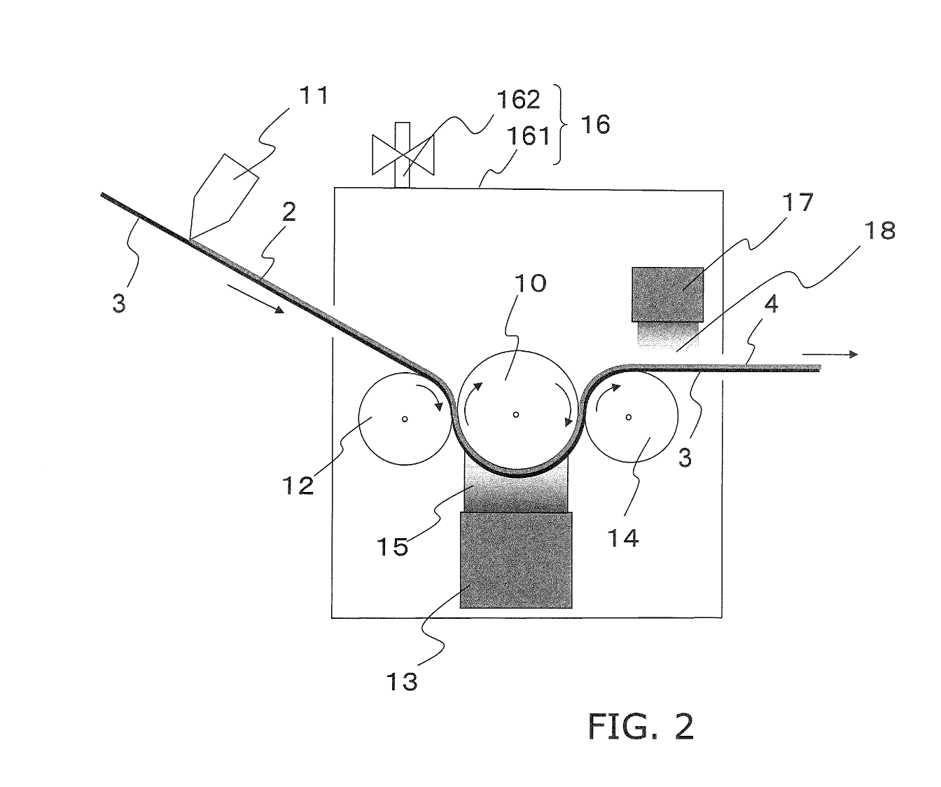

FIG. 2 is a simplified diagram of the device for manufacturing a tape-like pattern medium pertaining to Embodiment 1, and shows how the tape-like pattern medium is manufactured continuously.

As shown in FIG. 2, the device for manufacturing a tape-like pattern medium in Embodiment 1 continuously manufactures a tape-like pattern medium by roll-to-roll method, and comprises a coating component 11, a master stamper roll 10, nip rolls 12 and 14, an irradiation component 13, an air blocker 16, and an additional irradiation component 17.

The coating component 11 is made up of a die or the like, and forms an ultraviolet curing resin layer 2 by coating the film substrate 3 with an ultraviolet curing resin.

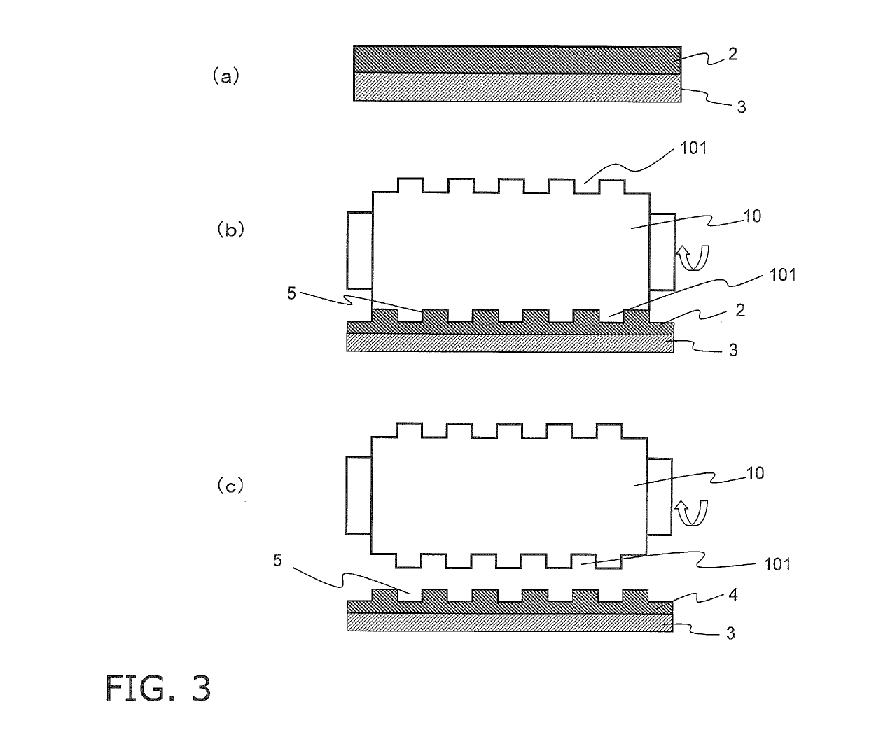

The master stamper roll 10 is an example of a master stamper, and has a texture pattern 101 (see FIG. 3b) formed on its surface in the rotation direction. This texture pattern 101 is transferred to the ultraviolet curing resin layer 2, forming the texture pattern 5 (see FIG. 1) on the ultraviolet curing resin layer 2.

The nip roll 12 is disposed upstream of the master stamper roll 10 (using the conveyance direction of the film substrate 3 as a reference), and the nip roll 14 is disposed downstream of the master stamper roll 10 (using the same reference). The ultraviolet curing resin layer 2 is put in close contact with the surface of the master stamper roll 10 between the nip roll 12 and the nip roll 14. Also, the nip roll 12 conveys the film substrate 3 so as to put the ultraviolet curing resin layer 2 in close contact with the surface of the master stamper roll 10, and the nip roll 14 conveys the film substrate 3 so that the film substrate 3 will separate from the surface of the master stamper roll 10 after the ultraviolet curing resin layer 2 has been formed.

The irradiation component 13 is disposed between the nip roll 12 and the nip roll 14 so as to be opposite the master stamper roll 10. From this irradiation component 13, ultraviolet rays 15 are emitted through the film substrate 3 and directed at the ultraviolet curing resin layer 2 in a state of being in close contact with the master stamper roll 10.

The additional irradiation component 17 is disposed downstream of the master stamper roll 10. This additional irradiation component 17 is used to emit ultraviolet rays 18 from the ultraviolet curing resin layer 2 side at the film substrate 3 that has been irradiated with the ultraviolet rays 15 by the irradiation component 13 and has been separated from the master stamper roll 10.

The air blocker 16 is constituted by a chamber 161 formed so as to cover the nip rolls 12 and 14, the irradiation component 13, the master stamper roll 10, and the additional irradiation component 17, a gas supply component 162 that supplies gas into the chamber 161, and so forth, and can block air from coming into the chamber by supplying nitrogen or the like and thereby putting the inside of the chamber 161 in a pressurized state.

Although not shown in FIG. 2, a dryer for drying the ultraviolet curing resin coating may be provided between the coating component 11 and the master stamper roll 10.

### 1-3. Method of Manufacturing Tape-Like Pattern Medium

The method for manufacturing a tape-like pattern medium will now be described through reference to FIGS. 2 to 4.

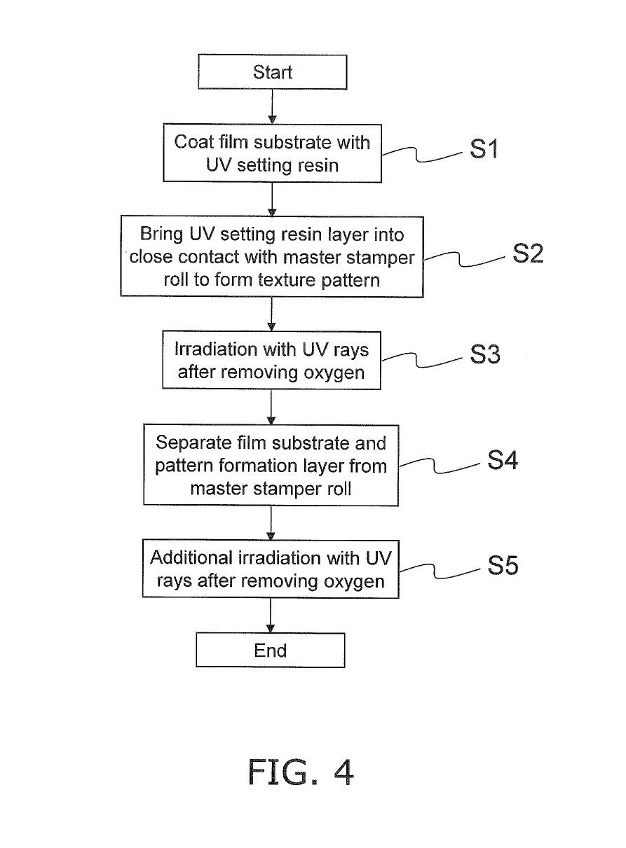

FIGS. 3a to 3c are simplified cross sections illustrating a method of manufacturing a tape-like pattern medium. FIG. 4 is a flowchart of the steps entailed by the manufacture of a tape-like pattern medium.

As shown in FIGS. 2, 3a, and 4, in the coating step 51, the coating component 11 coats the film substrate 3 with an ultraviolet curing resin in a thickness of 1.0 μm or less, forming the ultraviolet curing resin layer 2.

Then, as shown in FIGS. 2, 3b, and 4, in the pattern formation step S2, the face on the ultraviolet curing resin layer 2 side of the film substrate 3 on which the ultraviolet curing resin layer 2 has been formed is pressed against the master stamper roll 10, and the texture pattern 5 corresponding to the texture pattern 101 formed on the surface of the master stamper roll 10 is formed on the ultraviolet curing resin layer 2.

Then, as shown in FIGS. 2 and 4, in the irradiation step S3, the irradiation component 13 emits the ultraviolet rays 15 from the film substrate 3 side to cur the ultraviolet curing resin layer 2.

After this, as shown in FIGS. 2, 3d, and 4, in the separation step S4, the master stamper roll 10 is removed from the ultraviolet curing resin layer 2 side of the film substrate 3. Then, in the additional irradiation step S5, the film substrate 3 removed from the master stamper roll 10 is irradiated with the ultraviolet rays 18 from the ultraviolet curing resin layer 2 side by the additional irradiation component 17. This completes the transfer of the texture pattern to the ultraviolet curing resin layer 2, and forms the pattern resin layer 4.

The tape-like pattern medium of Embodiment 1 can be produced by the above steps.

Next, the ultraviolet curing resin, the film substrate, and so forth used in this embodiment will be described in greater detail by using working examples.

As discussed above, an ultraviolet curing resin that includes a photopolymerization initiator and is made up of an acrylic ester monomer, an acrylic ester oligomer, or both is used as the ultraviolet curing resin.

Glass, polycarbonate, polyester, aramid, or another film substrate having optical transmissivity is used as the film substrate 3.

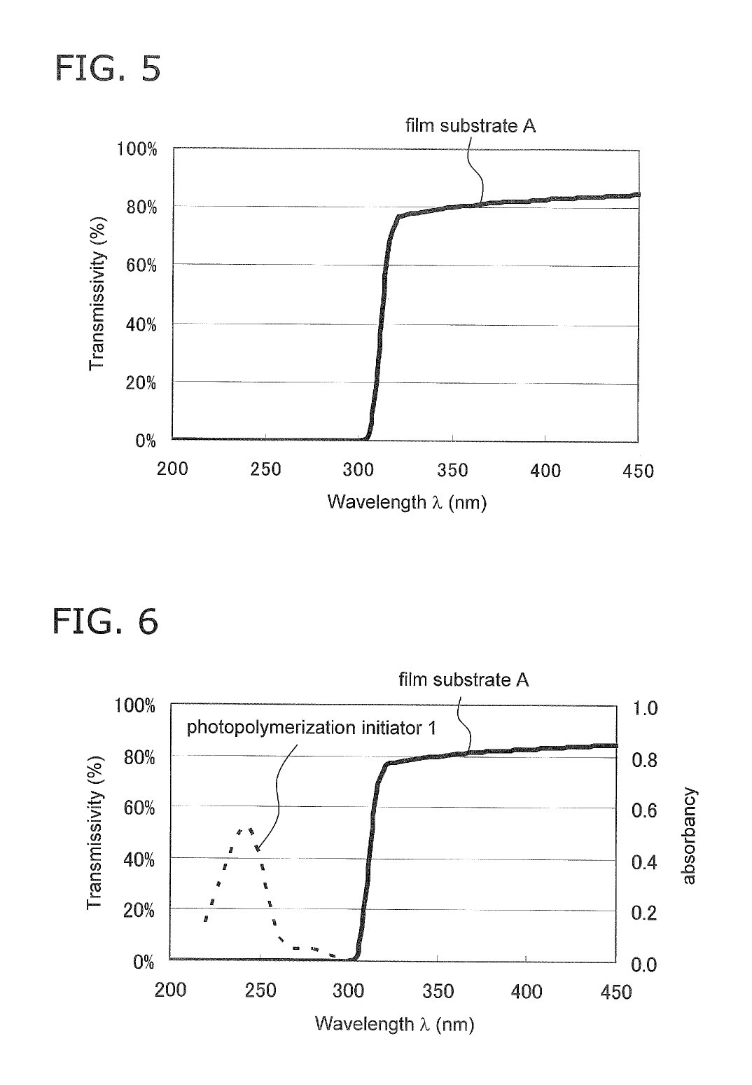

In this embodiment, a film substrate A having the ultraviolet ray transmissivity shown in FIG. 5 is used as the above-mentioned film substrate 3. FIG. 5 is a graph of the transmissivity versus wavelength of the film substrate A. The vertical axis on the left side is the transmissivity (%), and the horizontal axis is the wavelength λ (nm). As shown in FIG. 5, the film substrate A begins transmitting light near 300 nm, and has transmissivity of approximately 80% at 320 nm and above.

The required amount of ultraviolet rays will not be obtained if the ultraviolet rays needed for curing the ultraviolet curing resin layer 2 are absorbed by the film substrate A. Therefore, the curing is inadequate, and a pattern resin layer 4 having the targeted mechanical strength (a pencil hardness of at least 3H) cannot be formed. Also, when using a method that solves the problem of inadequate curing by increasing the amount of photopolymerization initiator and the amount of ultraviolet irradiation, an increase in the amount of photopolymerization initiator causes more of the unreacted photopolymerization initiator to remain behind, which leads to a drop in mechanical strength. If the amount of UV irradiation is increased, however, the longer curing time results in low production efficiency. And if additional ultraviolet irradiation is performed to compensate for inadequate curing after pattern formation, as illustrated in FIG. 10, if the resin thickness is 1.0 μm or less, impairment of curing by oxygen will make it difficult to promote sufficient curing of the pattern resin layer.

To solve these problems, it is preferable to use an ultraviolet curing resin in which is selectively used a photopolymerization initiator having spectral absorption of a wavelength band that will not be blocked by the film substrate 3 in the transfer of the texture pattern, thoroughly cure the pattern resin layer in a state of no curing impairment by oxygen by blocking out the air at the stage of transferring the texture pattern, and thereby obtain a pattern resin layer with high mechanical strength.

### WORKING EXAMPLES

An embodiment of the present invention will now be described further by using Comparative Examples 1 to 3 and Working Example 1.

Difference in Curing due to Photopolymerization Initiators with Different Absorbancies

As Comparative Examples 1 to 3 and Working Example 1, photopolymerization initiators having four different absorbancies with respect to the spectral transmissivity at the actual film thickness of the film substrate 3 were used to perform the curing of an ultraviolet curing resin in a state in which oxygen was blocked off (in the absence of oxygen), and the curing was tested.

FIGS. 6 to 8 are graphs of absorbancy versus wavelength for the photopolymerization initiators 1 to 3 in Comparative Examples 1 to 3, respectively. The horizontal axis is the wavelength λ (nm), and the vertical axis on the right side is the absorbancy. FIGS. 6 to 8 are also graphs of the film substrate A in FIG. 5, with the graphs of the film substrate A being shown with a solid line, and the graphs of the photopolymerization initiators 1 to 3 with a dotted line.

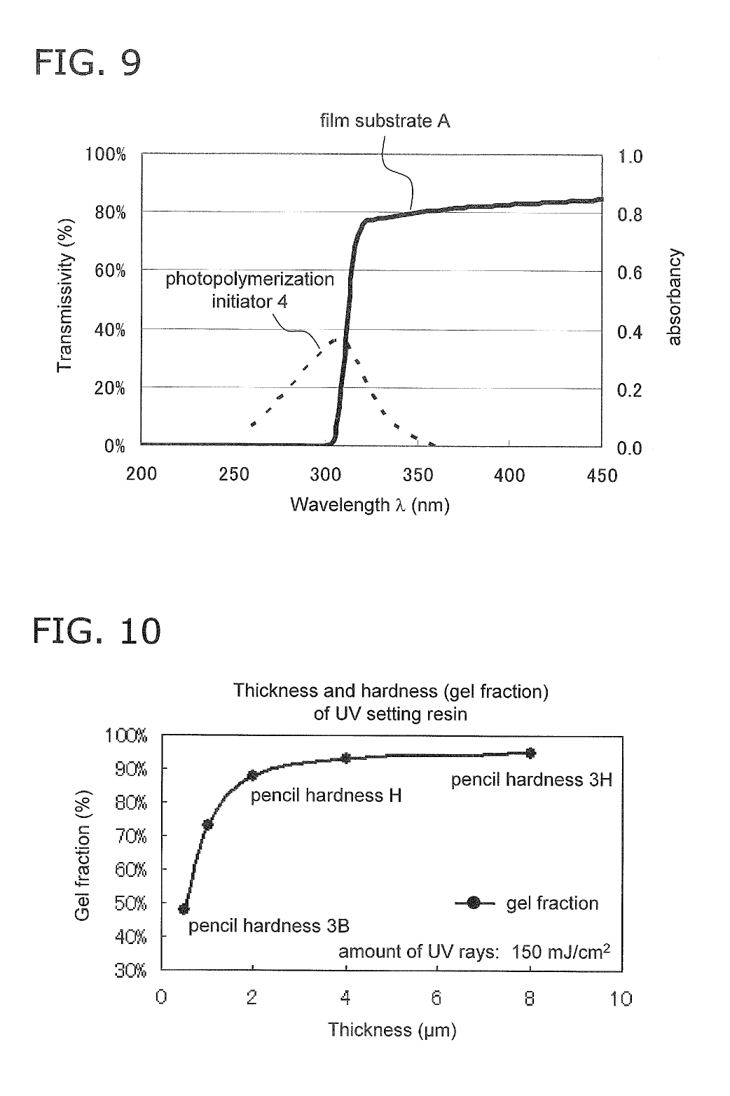

FIG. 9 is a graph of absorbancy versus wavelength for the photopolymerization initiator 4 of Working Example 1. The vertical and horizontal axes are the same as in FIG. 6. FIG. 9 is also similar to FIG. 6 in that it also shows a graph of the film substrate A in FIG. 5, with the graph of the film substrate A being shown with a solid line, and the graph of the photopolymerization initiator 4 with a dotted line.

The absorbancy of the photopolymerization initiators shown in FIGS. 6 to 9 indicates the absorbancy when the photopolymerization initiators 1 to 4 were diluted to 0.001% with an organic solvent.

Table 1 shows the degree of curing of the ultraviolet curing resin obtained with the photopolymerization initiators 1 to 4 of Comparative Examples 1 to 3 and Working Example 1. The extent of pitting resistance against an organic solvent (methyl ethyl ketone) and the pencil hardness were used as indexes of the degree of curing.

TABLE 1

| | PP initiator 1 | PP initiator 2 | PP initiator 3 | PP initiator 4 |
|---|---|---|---|---|
| Solvent wipe | pitting | pitting | no pitting | no pitting |
| test | | | | |
| Pencil hardness | 3B to 2B | B | 2H to 3H | 3H |

With a combination of the film substrate A and an ultraviolet curing resin containing one of the photopolymerization (PP) initiators 1 to 3 of Comparative Examples 1 to 3 shown in FIGS. 6 to 8, the ultraviolet rays needed for curing were blocked by the film substrate A, resulting in insufficient curing of the ultraviolet curing resin layer. Therefore, as shown in Table 1, what ends up being formed is a pattern resin layer 4 with insufficient mechanical strength, having a pencil hardness of less than 3H.

As shown in FIG. 9, with a combination of the film substrate A and an ultraviolet curing resin containing the photopolymerization initiator 4 of Working Example 1, since the peak wavelength of the absorbancy of the photopolymerization initiator 4 is located more toward a longer wavelength than in Comparative Examples 1 to 3, the photopolymerization initiator 4 will be able to absorb a greater proportion of the light transmitted by the film substrate 3, and the spectral absorption of the film substrate A will have less of an effect. Therefore, the ultraviolet curing resin layer 2 will cure better, and even without an increase in the added amount of photopolymerization initiator or the amount of ultraviolet irradiation, a pattern resin layer 4 with high mechanical strength (a pencil hardness of 3H) can be efficiently and continuously formed, as shown in Table 1.

Usage examples of the photopolymerization initiator added to an actual ultraviolet curing resin include types having an optical absorbancy band of 310 to 400 nm, which is the ultraviolet wavelength transmitted by the film substrate A. For instance, examples oxime ester-based compounds include Irgacure OXE01 and Irgacure OXE02, while examples of α-aminoketone-based compounds include Irgacure 907, Irgacure 369, and Irgacure 379 (all manufactured by BASF). Combinations of these may also be used. The added amount is preferably 1 to 6%, and more preferably 3 to 5%. If too much is added, however, it will actually end up lowering the hardness.

As shown in FIG. 9, if there is an optical peak of the photopolymerization initiator near 300 nm, at which the spectral transmissivity of the film substrate A increases with respect to a specific photopolymerization initiator added amount and ultraviolet irradiation amount, then the decrease in mechanical strength caused by curing impairment of the spectral transmissivity had by the film substrate can be avoided even without increasing the photopolymerization initiator added amount and ultraviolet irradiation amount.

Difference in Curing when Oxygen is and is Not Blocked

In this example, additional ultraviolet curing was performed after the texture pattern 5 was formed in the ultraviolet curing resin layer 2 by intentionally weakening the curing by the irradiation component 13 in the formation of the texture pattern 5, and the difference in the curing was then tested for when oxygen was blocked and when oxygen was not blocked. In Working Examples 2 to 4, the additional ultraviolet irradiation was conducted in a state in which oxygen was blocked by N₂ purging (that is, in the absence of oxygen), and at three different ultraviolet irradiation levels: 500 mJ/cm², 1000 mJ/cm², and 1500 mJ/cm². In Comparative Examples 4 to 6, the additional ultraviolet irradiation was conducted under an air environment without any N₂ purging (that is, in the presence of oxygen), and at three different ultraviolet irradiation levels: 500 mJ/cm², 1000 mJ/cm², and 1500 mJ/cm². After this additional ultraviolet irradiation, the gel fraction was measured for both the working examples and the comparative examples. The greater is the value for the gel fraction, the higher is the degree of curing. The thickness of the ultraviolet curing resin layer 2 in the additional irradiation was 0.3 μm.

FIG. 11a is a table of the results of Working Examples 2 to 4 and Comparative Examples 4 to 6. FIG. 11b is a graph of the table in FIG. 11a. It can be seen from the results in FIGS. 11a and 11b, that the gel fraction was larger and the degree of curing was higher when the ultraviolet irradiation was performed in the absence of oxygen (when oxygen was blocked by N₂ purging) than when the ultraviolet irradiation was performed under an air environment (in the presence of oxygen) with no N₂ purging.

### 1-4. Effect, etc.

As discussed above, in this embodiment, the method of manufacturing a tape-like pattern medium comprises the coating step S1, the pattern formation step S2, and the irradiation step S3. In the coating step S1, the surface of the film substrate 3 is coated with an ultraviolet curing resin containing a photopolymerization initiator having absorption of ultraviolet rays of a wavelength transmitted by the film substrate 3, thereby forming the ultraviolet curing resin layer 2. In the pattern formation step S2, the ultraviolet curing resin layer 2 is brought into close contact with the master stamper roll 10 for form a texture pattern on the ultraviolet curing resin layer 2 corresponding to the texture pattern of the master stamper roll 10. In the irradiation step S3, the ultraviolet curing resin layer 2 on which the texture pattern has been formed is irradiated with ultraviolet rays in a state in which oxygen has been removed from the surroundings, thereby curing the ultraviolet curing resin layer 2.

Consequently, the irradiation step is performed in the absence of oxygen, using an ultraviolet curing resin containing a photopolymerization initiator having absorption of ultraviolet rays with a wavelength transmitted by the film substrate 3. Accordingly, a tape-like pattern medium with improved mechanical strength can be manufactured efficiently.

Furthermore, a tape-like pattern medium having a pattern resin layer with improved mechanical strength can be formed continuously.

It is also possible to transfer the texture pattern of the master stamper more stably.

Also, a tape-like pattern medium with improved mechanical strength can be efficiently manufactured even when the ultraviolet curing resin layer is thin in the irradiation step.

Also, in this embodiment, the method of manufacturing a tape-like pattern medium is such that the ultraviolet curing resin includes an acrylic ester monomer and/or an acrylic ester oligomer.

Consequently, a tape-like pattern medium with improved mechanical strength can be manufactured efficiently.

Also, in this embodiment, the method of manufacturing a tape-like pattern medium is such that the thickness of the ultraviolet curing resin layer when it is in close contact with the master stamper is 1.0 μm or less.

Consequently, a tape-like pattern medium with improved mechanical strength can be efficiently manufactured even when the ultraviolet curing resin layer is thin in the irradiation step.

Also, in this embodiment, the tape-like pattern medium comprises the film substrate 3 and the pattern resin layer 4. The pattern resin layer 4 is provided to the surface of the film substrate 3, and a texture pattern is formed that corresponds to the texture pattern of the master stamper. The pattern resin layer 4 is formed by an ultraviolet curing resin containing a photopolymerization initiator having absorption of ultraviolet rays with a wavelength transmitted by the film substrate 3, and the thickness of the pattern resin layer 4 is 1.0 μm or less.

Consequently, a tape-like pattern medium can be provided in which the resin layer is thin and the mechanical strength is improved.

Also, in this embodiment, the device for manufacturing a tape-like pattern medium comprises the coating component 11, the master stamper roll 10, the nip rolls 12 and 14, the irradiation component 13, and the air blocker 16. The coating component 11 forms the ultraviolet curing resin layer 2 by coating the surface of the film substrate 3 with an ultraviolet curing resin containing a photopolymerization initiator having absorption of ultraviolet rays with a wavelength transmitted by the film substrate 3. The master stamper roll 10 has a texture pattern on its surface. The nip rolls 12 and 14 convey the film substrate on which the ultraviolet curing resin layer 2 has been formed, while putting it in close contact with the master stamper roll 10, in order to form a texture pattern on the ultraviolet curing resin layer 2 corresponding to the texture pattern of the master stamper. The irradiation component 13 directs the ultraviolet rays 15 at the ultraviolet curing resin layer 2 that is in close contact with the master stamper roll 10, thereby curing the ultraviolet curing resin layer 2. The air blocker 16 removes oxygen from the region where the ultraviolet curing resin layer 2 is irradiated with the ultraviolet rays 15.

Consequently, ultraviolet irradiation is performed in the absence of oxygen, using an ultraviolet curing resin containing a photopolymerization initiator having absorption of ultraviolet rays of a wavelength transmitted by the film substrate 3. Accordingly, a tape-like pattern medium with improved mechanical strength can be manufactured efficiently.

Furthermore, a tape-like pattern medium having a pattern resin layer with improved mechanical strength can be formed continuously.

Also, a tape-like pattern medium with improved mechanical strength can be efficiently manufactured even when the ultraviolet curing resin layer is thin in the irradiation step.

Also, in this embodiment, the device for manufacturing a tape-like pattern medium is such that the ultraviolet curing resin contains an acrylic ester monomer and/or an acrylic ester oligomer.

Consequently, a tape-like pattern medium with improved mechanical strength can be manufactured efficiently.

Also, in this embodiment, the device for manufacturing a tape-like pattern medium is such that the thickness of the ultraviolet curing resin layer when it is in close contact with the master stamper is 1.0 μm or less.

Consequently, a tape-like pattern medium with improved mechanical strength can be efficiently manufactured even when the ultraviolet curing resin layer is thin in the irradiation step.

### Other Embodiments

Embodiment 1 was described above as an example of the technology disclosed herein, but the technology disclosed herein is not limited to this, and can also be applied to embodiments with modifications, substitutions, additions, omissions, and so forth made as needed.

Examples of other embodiments will now be given.

In Embodiment 1, the nip rolls 12 and 14, which served as both conveyor and close contact state formation component, were described as an example of a conveyor and a close contact state formation component. The conveyor need only be able to convey the film substrate 3, and the close contact state formation component need only be able to form a close contact state in which the film substrate 3 on which the ultraviolet curing resin layer 2 has been formed is brought into close contact with the master stamper roll 10 in order to form the texture pattern 5 corresponding to the texture pattern 101 of the master stamper roll 10 on the ultraviolet curing resin layer 2, and therefore these are not limited to the configuration of the nip rolls 12 and 14. For example, the conveyor and the close contact state formation component may be provided separately. More specifically, as shown in FIG. 12, conveyor rolls 21 and 22 (examples of conveyors) may be disposed on the upstream and downstream sides of the master stamper roll 10, and guide members 20 and 22 (examples of close contact state formation components) may be provided. The guide member 20 is disposed between the conveyor roll 21 and the master stamper roll 10, and guides the film substrate 3 so that the ultraviolet curing resin layer 2 side thereof comes into close contact with the master stamper roll 10. The guide member 22 is disposed between the master stamper roll 10 and the conveyor roll 23, and guides the film substrate 3 so that the pattern resin layer 4 thereof separates from the master stamper roll 10.

In Embodiment 1, the air blocker 16 was described as an example of an oxygen removal component. The oxygen removal component need only remove oxygen from the region where the ultraviolet curing resin layer 2 is irradiated with ultraviolet rays, and is not limited to the air blocker 16 shown in FIG. 2. For example, a chamber may be formed by a member that transmits ultraviolet rays, and the irradiation component 13 disposed outside the chamber.

In Embodiment 1, it was described that the film substrate 3 was coated with the ultraviolet curing resin in a thickness of 1.0 μm or less. The thickness of the ultraviolet curing resin layer 2 need only be 1.0 μm or less in a state in which this layer is in close contact with the master stamper roll 10, so the thickness of the ultraviolet curing resin layer 2 formed when the coating component 11 coats the film substrate 3 with the ultraviolet curing resin may be greater than 1.0 μm.

Also, in the above embodiment, the thickness of the pattern resin layer 4 on which the texture pattern 5 was formed was 1.0 μm or less, but it is preferably 0.3 μm or less.

If the target value for the thickness of the pattern resin layer 4 is set thinner, such as 0.3±0.05 μm, then the overall thickness of the tape-like pattern medium will be reduced, so if the takeup amount is determined so that the tape-like pattern medium will be taken up inside a cassette, then the possible takeup length can be increased, and the amount of memory per cassette will be greater. It was confirmed that good smoothness is obtained by coating with the ultraviolet curing resin in a thickness of 0.22 μm.

In Embodiment 1, the additional irradiation component 17 was provided, and the effect of this additional irradiation component 17 is discussed below.

Since curing is slower with a thin-film ultraviolet curing resin layer, the problem of insufficient curing can be solved by installing a plurality of ultraviolet irradiation devices as the irradiation component 13 during formation of the texture pattern (imprinting) on the ultraviolet curing resin layer 2.

However, there is the risk that problems will be encountered, such as (i) damage to the film substrate 3 caused by thermal rays and heat generation by the plurality of ultraviolet irradiation devices, (ii) limited selection of devices due to the small space in which the ultraviolet irradiation device is installed, and (iii) damage to the ultraviolet irradiation device due to more heat being generated by the plurality of ultraviolet irradiation devices. Accordingly, additional ultraviolet irradiation can be performed, and curing to the targeted level can be accomplished by installing the additional irradiation component 17 after the formation of the texture pattern (after imprinting), and avoiding the installation of a plurality of ultraviolet irradiation devices.

Thus dispersing the ultraviolet irradiation devices reduces the risk that the problems mentioned above in (i) to (iii) will occur.

If the installation space of the ultraviolet irradiation device is large because of a large diameter of the master stamper roll 10, etc., or if a suitable device can be selected, or if the ultraviolet irradiation device will not be damaged by heat generation, for example, a plurality of irradiation components 13 may be disposed, and the additional irradiation component 17 need not be provided. Also, not only when there are one or more ultraviolet irradiation devices provided as the irradiation component 13, as long as the curing of the ultraviolet curing resin layer 2 by the irradiation component 13 will reach the target value, then no additional irradiation component 17 need be provided.

An embodiment was described above as an example of the technology disclosed herein, and the appended drawings and detailed description were provided to that end.

Therefore, the constituent elements illustrated in the appended drawings and discussed in the Specification can encompass not only those constituent elements which are essential to solving the problem, but also constituent elements that are not essential to solving the problem. Accordingly, just because these non-essential constituent elements are illustrated in the appended drawings and discussed in the Specification, it should not be concluded that these non-essential constituent elements are essential.

Also, the above embodiments were given to illustrate examples of the technology disclosed herein, so various modifications, substitutions, additions, omissions, and so forth can be made within the scope of the patent claims or equivalents thereof.

### INDUSTRIAL APPLICABILITY

This disclosure can be applied to a method of manufacturing a tape-like pattern medium, with which a tape-like pattern medium with improved mechanical strength can be efficiently manufactured, and to a tape-like pattern medium and a device for manufacturing a tape-like pattern medium.

### REFERENCE SIGNS LIST

2 ultraviolet curing resin layer

3 film substrate

4 pattern resin layer

5 texture pattern

10 master stamper roll

11 coating component

12, 14 nip roll

13 irradiation component

15 ultraviolet rays

16 air blocker

20, 22 guide member

21, 23 conveyor roll

101 texture pattern

161 chamber

162 gas supply component

1. A method of manufacturing a tape-like pattern medium, comprising:
a coating step of forming an ultraviolet curing resin layer by coating a film substrate surface with an ultraviolet curing resin containing a photopolymerization initiator that absorbs ultraviolet rays of a wavelength that will pass through the film substrate;
a pattern formation step of bringing the ultraviolet curing resin layer into close contact with a roll-shaped master stamper and forming a texture pattern corresponding to a texture pattern of the master stamper in the ultraviolet curing resin layer; and
an irradiation step of curing the ultraviolet curing resin layer by irradiating the ultraviolet curing resin layer in which the texture pattern has been formed with the ultraviolet rays in a state in which the surrounding oxygen has been removed.

2. The method of manufacturing a tape-like pattern medium according to claim 1, wherein the ultraviolet curing resin includes an acrylic ester monomer and/or an acrylic ester oligomer.

3. The method of manufacturing a tape-like pattern medium according to claim 1, wherein the thickness of the ultraviolet curing resin layer in a state of being in close contact with the master stamper is no more than 1.0 μm.

4. A tape-like pattern medium, comprising:
a film substrate; and
a pattern resin layer that is provided to a surface of a film substrate and on which is formed a texture pattern corresponding to a texture pattern of a master stamper,
wherein the pattern resin layer is formed by an ultraviolet curing resin containing a photopolymerization initiator that absorbs ultraviolet rays of a wavelength that will pass through the film substrate, and
the thickness of the ultraviolet curing resin layer is no more than 1.0 μm.

5. The tape-like pattern medium according to claim 4, wherein the ultraviolet curing resin includes an acrylic ester monomer and/or an acrylic ester oligomer.

6. A device for manufacturing a tape-like pattern medium, comprising:
a conveyor for conveying a film substrate;
a coating component for forming an ultraviolet curing resin layer by coating a surface of a conveyed film substrate with an ultraviolet curing resin containing a photopolymerization initiator that absorbs ultraviolet rays of a wavelength that will pass through the film substrate;
a roll-shaped master stamper having a texture pattern on its surface;
a close contact state formation component for forming a close contact state in which a film substrate on which the ultraviolet curing resin layer has been formed is brought into close contact with the roll-shaped master stamper in order to form a texture pattern corresponding to a texture pattern of the master stamper on the ultraviolet curing resin layer;
an irradiation component for curing the ultraviolet curing resin layer by irradiating the ultraviolet curing resin layer in close contact with the master stamper with the ultraviolet rays; and
an oxygen removal component for removing oxygen from the region where the ultraviolet curing resin layer is irradiated with the ultraviolet rays.

7. The device for manufacturing a tape-like pattern medium according to claim 6, wherein the ultraviolet curing resin includes an acrylic ester monomer and/or an acrylic ester oligomer.

8. The device for manufacturing a tape-like pattern medium according to claim 6, wherein the thickness of the ultraviolet curing resin layer in a state of being in close contact with the master stamper is no more than 1.0 μm.
